(19) United States
(12) Patent Application Publication
(10) Pub. No.: US 2007/0137750 A1
(43) Pub. Date: Jun. 21, 2007

(54) ANTI-SKID STRUCTURE BETWEEN BODY AND RIM OF HOLLOW-SHAPED FOAM WHEEL

(76) Inventor: Wen-Yao Han, Tainan City (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/306,133

(22) Filed: Dec. 16, 2005

(51) Int. Cl. B60C 25/00; B60C 5/16

(52) U.S. Cl. 152/384

(57) ABSTRACT

The invention relates to an anti-skid structure between a body and a rim of a hollow foam wheel, and more particularly, to a hollow-shaped foam wheel body put around a rim. The wheel body includes two flanges that are thick and close to each other. Pluralities of retaining flakes are disposed apart on the surface of the rim covered by the wheel body, and pluralities of protrusions are disposed apart on the surface of the flanges corresponding to the wheel body. As the wheel body is tightly put around the rim, the protrusions and the retaining flakes block one another, avoiding the skid between the wheel body and the rim. Furthermore, the pressure on the surface of the wheel is conducted to the flanges leaning on each other through the sidewalls thereof, and is then balanced. Hence, the deformation of the wheel body is decreased. The wheel can carry more load and serve as an optimal buffer when employed.

### CROSS-REFERENCES TO RELATED APPLICATIONS

Not Applicable

### STATEMENT REGARDING FEDERALLY SPONSORED RESEARCH OR DEVELOPMENT

Not Applicable

Description

### BACKGROUND OF THE INVENTION

A conventional hollow-shaped foam wheel is shown in FIG. 1 and FIG. 2. The structure thereof comprises a rim 1, a hollow wheel body 2, flanges 21 spaced apart and disposed in the inner periphery of the wheel body 2, and spokes 11 deployed around the rim 1. The rim 1 includes a concave part for casing the wheel body 2. Protruding blocks 12 bulge from the concave part. The wheel body 2 is compactly installed into the concave part of the rim 1. Owing to the obstruction of the protruding blocks 12, the flanges 21 of the wheel body 2 are prevented from skidding inward.

However, the flanges 21 on the sides inevitably move towards the center of the concave of the rim 1 due to pressure induced along the sides of the wheel body 2 when the foam wheel is loaded. Because the protruding blocks 12 are too small to stop the flanges 21 skidding inward, the sidewalls of the wheel body 2 are inclined inwardly, resulting in a flatter surface of the wheel. Accordingly, the wheel body 2 is not capable of bearing heavy weights, and does not serve as an adequate buffer. It thus becomes uncomfortable when used.

On the other hand, the movement of the wheel body 2 on the ground is driven by the rotation of the rim 1. Since the friction of the wheel body 2 against the ground is much greater than that between the wheel body 2 and the rim 1, the drag of the protruding blocks 12 on the wheel body 2 plays an important role. Though each protruding block 12 pierces the wheel body 2 directly for blocking and avoiding the wheel body 2 sliding against the rim 1, the protruding block 12 still loses its capacity of obstructing, which may even damage the wheel body 2 after being used for a long time. That is because the contact area between the fine protruding block 12 and the wheel body 2 is quite small, and the wheel body 2 is made of porous and soft foam.

### SUMMARY OF THE INVENTION

It is a primary object of the invention to provide a hollow-shaped foam wheel body put around a rim, which includes two thicker flanges disposed in the inner periphery thereof and leaning on each other. Pluralities of protrusions are disposed apart on the surface of the flanges. Pluralities of retaining flakes are disposed apart on the surface of the rim covered by the wheel body, and obstruct the protrusions.

As the wheel body of the foam wheel is pressed by heavy loads, the stress induced thereby is conducted to the flanges through the sidewalls of the wheel body. Since these two flanges lean against each other, the stress is counteracted mutually, decreasing the degree of deformation of the wheel body. Thus, the wheel body can carry more loadings and serve as an ideal buffer.

Furthermore, the protrusions in the inner periphery of the wheel body and the retaining flakes of the rim are blocked one another, and hence the wheel body is prevented from skidding on the rim.

### BRIEF DESCRIPTION OF THE DRAWINGS

The foregoing aspects, as well as many of the attendant advantages and features of this invention will become more apparent by reference to the following detailed description, when taken in conjunction with the accompanying drawings, wherein:

FIG. 1 illustrates the structure of a conventional hollow-shaped foam wheel;

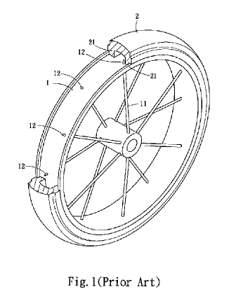

FIG. 2 is a cross-sectional view of a conventional hollow-shaped foam wheel;

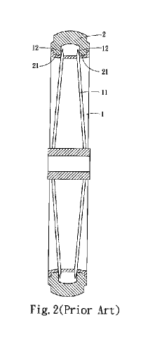

FIG. 3 illustrates the structure of a wheel according to one embodiment of the invention;

FIG. 4 is an exploded diagram showing a wheel according to one embodiment of the invention;

FIG. 5 shows a cross-sectional view of a wheel according to one embodiment of the invention; and

FIG. 6 is the cross-section along line A-A in FIG. 5.

### DETAILED DESCRIPTION OF THE INVENTION

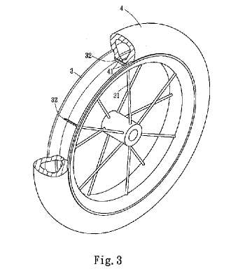

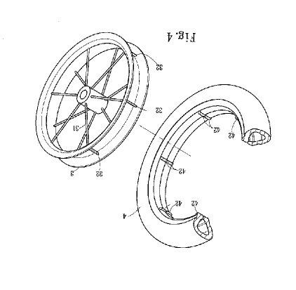

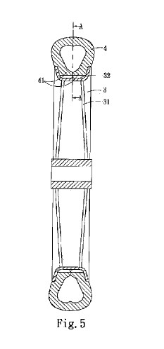

Referring to FIGS. 3-5, the structure in accordance with one embodiment of the invention comprises a rim 3 having spokes 31 and a plurality of retaining flakes 32 disposed apart on the surface of the rim 3, which is reserved for installing a wheel body 4. The wheel body 4 is put around the rim 3 tight. Two flanges 41 disposed face to face along the inner periphery of the wheel body 4 are thick and lean on each other. A plurality of protrusions 42 are further disposed on the surface of the flanges 41 separately, and are interlaced with the retaining flakes 32. Accordingly, the protrusions 42 and the retaining flakes 32 may block one another.

As the wheel body 4 of the foam wheel is pressed by heavy loads, the stress induced thereby is conducted to the flanges 41 through the sidewalls of the wheel body 4. Because these two flanges 41 lean against each other, the stress therefrom is mutually counteracted. The deformation of the wheel body 4 is thus decreased. Therefore, the wheel body 4 can carry more load and is maintained in a state of elastic buffer.

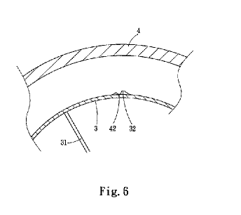

Moreover, the entire flanges 41 of the wheel body 4 are put tightly around the rim 3 as shown in FIG. 6. The retaining flakes 32 disposed on the rim 3 may lodge in the wheel body 4, and thus block the same. The protrusions 42 are thicker than other regions of the wheel body 4. Consequently, the protrusions 42 and the retaining flakes 32 may block one another, preventing the wheel body 4 from skidding on the rim 3.

While the invention has been particularly shown and described with reference to the preferred embodiments thereof, these are, of course, merely examples to help clarify the invention and are not intended to limit the invention. It will be understood by those skilled in the art that various changes, modifications, and alterations in form and detail may be made therein without departing from the spirit and scope of the invention, as set forth in the following claims.

What is claimed is:

1. An anti-skid structure between a body and a rim of a hollow foam wheel including a hollow-shaped foam wheel body put tightly around a rim, wherein the improvement of the anti-skid structure comprises two thick flanges disposed in an inner periphery of the wheel body face to face and leaning on each other.

2. The anti-skid structure of claim 1, further comprising a plurality of retaining flakes disposed apart on a surface of the rim covered by the wheel body.

3. The anti-skid structure of claim 1, further comprising a plurality of protrusions disposed apart on a surface of the flange at an inner side of the wheel body.
